(19) United States
(12) Patent Application Publication
(10) Pub. No.: US 2003/0043787 A1
(43) Pub. Date: Mar. 6, 2003

(54) Interactive device control system for integrating the internet with the public switched telephone network

(76) Inventor: Harry E. Emerson III, Succasunna, NJ (US)

Correspondence Address: Ernest D. Buff, Ernest D. Buff & Associates, LLC, 245 South Street, Morristown, NJ, 07960, US

(21) Appl. No.: 10/228,748

(22) Filed: Aug. 27, 2002

Related U.S. Application Data
(60) Provisional application No. 60/317,055, filed on Sep. 4, 2001.

(51) Int. Cl. H04L 12/66

(52) U.S. Cl. 370/352; 370/400; 379/900

(57) ABSTRACT

An Interactive Device Control System has a method and means for providing device control, call control, and communications system information for telecommunications and Internet voice and multimedia communications. A communications system, service, or device offers the user of a communications device having a display screen, such as a screen phone, the ability to control or influence the functions of the communications system. The PSTN establishes and controls Internet communications between communications systems and user devices. Messages comprising information to be presented on the user's display are sent from the communications system, service, or device, and interactive responses from the user indicate the selected control function. Call control messages from the communications system to the PSTN execute the desired control function, such as transferring the call. The Interactive Device Control System operates across the Public Switched Telephone Network (PSTN) and the Internet, further enhancing the benefits of integrating the Internet with the PSTN.

This application claims the benefit of U.S. Provisional Patent Application No. 60/317,055, filed Sep. 4, 2001.

### BACKGROUND OF THE INVENTION

1. Field of fhe Invention

The present invention relates to the Internet and the Public Switched Telephone Network (PSTN); and more particularly to the integration of the Internet with the PSTN in a manner such that systems, services, and devices on either can communicate with systems, services, and devices on the other, so that the full benefit and unique characteristics of either network are available to these communications.

2. Description of the Prior Art

The Internet and the PSTN constitute discrete, independent networks from an architectural and operational perspective. Much is written about both networks, especially in terms of their architecture and operation. Consequently, the specification provided herein does not reconstruct that information other than providing general background information. The term “Internet” is commonly understood and used throughout the specification and claims in a conventional way. The Internet, in general, is an assemblage of interconnected routers that provide data transport services for server computers and user devices—typically PCs. The interconnection between routers is provided by private line data circuits, the main lines of which constitutes the Internet “backbone”. Internet Service Providers (ISPs) provide access to the Internet via dial up telephone lines with modems, and via dedicated arrangements such as T-1 circuits, cable modems on cable-TV systems, and DSL (Digital Subscriber Line) service.

The Internet is designed according to the Internet Protocol (IP), which provides detailed specifications for the construction, addressing, and routing of data packets (occasionally referred to as “messages” in this document). (The term “Internet Protocol” also is used loosely to refer to dozens of related protocols that are used in the Internet.) IP addresses are expressed as a series of digits separated by “dots” (periods), in the form XXX.XXX.XXX.XXX where XXX can be a number from 0 to 255. IP addresses provide a similar function on the Internet as telephone numbers provide on the PSTN. A communication with an Internet device can be established by sending a message addressed to the IP address of that device. Every device capable of communicating on the Internet has an IP address assigned to it, either permanently, or dynamically as needed. IP addresses in some environments are replaced with a proxy address; for purposes of this document, the term “IP address” shall refer to an actual IP address, or a proxy or other identifier translatable into an actual IP address. In some of these arrangements, the IP address may be indirectly associated with the device. For example, in a wireless handset arrangement, the provider's complex might provide Internet connections for wireless handsets on a proxy basis wherein the complex keeps track of IP number assignments used for each handset, but communicates with each handset based on a serial number or other unique identifying scheme. The same goal is accomplished, i.e. an Internet capable handset gets its own IP address, but with one level of indirection. In other arrangements proxies or agents act on behalf of a client system and substitute the proxy's IP addresses for the addresses of the client devices—in these arrangements the combination of the proxy address and the original client system address resolve to provide a unique IP address for each client system. Internet data packets contain the IP address of both the sending system and receiving system (the source and destination, respectively). Since IP messages always contain the IP addresses of both the sending and destination device, when a device receives an Internet message from a sending device, it will then possess the IP address of the sender and can send messages in reply. The two devices can then engage in a communication across the Internet since each has the IP address of the other.

Routers have internal tables that provide routing instructions, which relate IP addresses to the available data circuits and access lines. A router functions by reading the destination address in a data packet, and then forwarding the data packet on one of its data circuits or access lines according to the rules of the routing tables. A data packet gets forwarded from one router to another, pinballing its way across the Internet until it reaches a router that is connected to the destination system.

The term “Public Switched Telephone Network”, or PSTN, as used herein means the national and international telephone network, actuated when a user dials a telephone number associated with any other phone, causes it to ring, and if answered, is enabled to carry on a voice communication (or, more properly, a “voice grade” communication) with the person (or system) at the remote location. Just as the Internet is comprised of an aggregation of interconnected routers, the PSTN is comprised of an aggregation of interconnected local and long distance telephone switching systems. The local switching systems, referred to as telephone company (telco) central offices (CO), provide telephone subscriber services in a geographic area.

As used herein, the term “telephone central office switching system” refers generically to a class of systems, typically owned by the operating telephone company in any given area, which provide “local” telephony services to telephone subscribers in that area. Generally, the operating telephone company provides the “local loop” cabling and wiring from its central office to the physical location of each of its subscribers (a “telephone circuit”, or a “line”). A telephone central office might house several switching systems of this class, each serving up to 100,000 subscribers or more. The central office represents the hub of a wheel having thousands of spokes, each spoke being a physical pair of wires providing telephone service to a subscriber in that area. Subscribers in any given area are provided service by the central office situated in the center of the area. Outside that area the wires home to other similarly situated central offices. The telephone company connects the telephone circuit of a subscriber to an access connection on the switching system, and assigns a telephone number to that circuit. In operation, the switching system (or just “switch”) provides battery voltage on the phone line, sends dial tone to the subscriber line when the subscriber's phone goes off hook, receives the dialed digits, and then routes the call according to its internal instructions based on the called number.

Common manufactured switching systems of this class include the Lucent Technologies 5ESS, and the Nortel DMS100. All telephone central office-switching systems around the world are interconnected by “trunk” circuits that carry voice or voice grade telephone calls between systems, and most (if not all) such systems are also interconnected by a messaging network referred to as CCS/SS7 (Common Channel Signaling/Signaling System 7), or just SS7. Long distance calls to telephones outside of the area served by the local telephone company are typically routed to a long distance carrier, such as AT&T, MCI, or Sprint in the USA. The telephone central office switches connect via trunking and messaging circuits to a class of switching system referred to as a “toll switch”, such as the Lucent Technologies 4ESS, operated by a long distance carrier. Toll switches normally do not provide local telephone services.

Conventional communication vehicles comprise computers and telephones. Computers typically have telephone lines attached to them, and telephones oftentimes have computers attached to them; but there is no true integration that enables the blending of the Internet and the PSTN. The level of integration that is presently attained permits a computer to use a phone line to dial into the Internet. Once on the Internet, the computer can access another computer by entering its Internet Protocol (IP) address into application software such as a browser.

In an associated matter, there are now a variety of technologies that provide both Internet and PSTN connectivity. These technologies include: (i) Voice over IP (ii) DSL service; (iii) cable modem service delivered by cable-TV systems; (iv) fixed wireless systems; and (v) Internet capable cellular wireless systems. The following provides a brief review of these technologies.

In one aspect, the systems described herein relate to Voice over IP service. The term IP refers to the “Internet Protocol”, the basic protocol of the Internet, while the term Voice over IP refers to sending digitized voice across the Internet using the IP protocol. Several companies provide discount rate phone calls using “Voice over IP” (VoIP) technology, wherein a long distance call of a client, typically a Personal Computer (PC) user, is carried over the Internet to a VoIP interface device in the vicinity of the called party. Such VoIP technology avoids the charges associated with placing a long distance call with a traditional long distance carrier. The interface device dials a local call on the PSTN to complete the connection for the VoIP client. Hence, the call travels partially over the Internet and partially over the PSTN as an analog call. A VoIP software application at the client device digitizes the user's voice and sends that as data messages across the Internet to the VoIP interface device. The VoIP interface device in turn converts the data messages to analog signals that are output onto the analog phone line. In the reverse direction, the VoIP interface device receives analog signals from the dialed phone and converts those analog signals to digital messages which it sends across the Internet to the VoIP client. The VoIP software at the client converts those digital messages to analog signals, which are output to the user via speakers.

In another aspect, the systems described herein relate to an Internet access technology currently being deployed that is referred to as DSL (Digital Subscriber Line) service. (The original acronym was ADSL, for Asynchronous Digital Subscriber Line.) Although there are some variations on the technology (now generically referred to as “xDSL”), it essentially involves an analog telephone line supplemented by a high frequency carrier signal superimposed on the telephone line by a pair of modems—one at the subscriber location, and one at the telephone company central office. The DSL carrier signal can carry high-speed data concurrently over the same phone line without interfering with the analog phone service. Other than being carried by the same physical wires, the phone line has no relationship to the DSL Internet service.

In another instance, the matter to be discussed relates to virtual phone service provided via cable-TV. Cable-TV service has been used to provide high-speed Internet access—the popular “cable modem” service. In addition, there are a number of current activities related to delivering alternative provider telephone service via the cable-TV distribution system. Similar to the Internet access service arrangement, the telephony service arrangement utilizes a “cable modem” to transmit and receive voice grade telephone calls. Other than being carried by the same physical cable, telephone service provided by cable-TV has no relationship to the cable modem Internet service.

A related matter is that of virtual phone service provided by the so-called fixed wireless arrangement, currently undergoing field trials in some areas, and by the newly introduced cellular telephone service with Internet access. Although these are substantially different services from a user perspective, the wireless infrastructure is much the same.

In each of these technologies, even though they provide both Internet and PSTN connectivity, the Internet aspect is separated from the telephony aspect.

The objective of this patent application is to describe an Interactive Device Control System which has the capability of integrating the Internet with the PSTN such that one device can control communications functions of another device.

In the current state of the art there are two inter-related messaging systems utilized within the PSTN. These are: (i) SS7; and (ii) ISDN (Integrated Services Digital Network), which incorporates a messaging system as an element of a broader product and service architecture. The SS7 messaging system extends through the major elements and systems of the PSTN, connecting virtually all of the local and long distance central offices, and carries call management messages relating to call setup and disconnection and similar call management functions. Whereas the SS7 messaging system is oriented toward providing messaging communications among and between the PSTN switching systems, the ISDN messaging system is oriented toward extending the PSTN messaging system to the end devices such as telephones and office telephone systems. Rather than going off hook and drawing dial tone from the local central office switching system to initiate a call, as analog phones do, an ISDN phone sends a packetized message to the switching system to initiate a call. Both the ISDN messaging system and the SS7 messaging system are based on the X.25/X.75 communications protocols. ISDN messages are carried on the SS7 messaging network. Disadvantageously, neither the SS7 nor the ISDN messaging systems carry messages of the nature described herein.

The capabilities of the Internet and the PSTN, as described above, do not incorporate a means for providing the features of an Interactive Device Control System as desired by this patent application. The current environment, rather, depends upon analog techniques to accomplish the limited forms of device control that are presently available.

For example, automated attendant systems are devices that steer incoming calls by providing voice prompts to the caller (“If you know your party's extension, please dial it now. If you would like to reach the accounting department, please dial 2 now . . . ”). The caller responds to the voice prompts by pressing the corresponding touch-tone dial button, causing the automated attendant system to step to the next menu tier, or to transfer the call as specified. Many such automated attendant systems have lengthy and multi-tiered menus that are time-consuming and difficult to follow (Do I want the customer service department or the repair department; was it 3 for customer service, or was it 9?). The current environment would be improved if there were a way for devices like automated attendant systems to visually present a menu of options which the caller could interactively respond to. However, the existing telephony environment does not offer a means for such operation.

There is a telephony technology called ADSI (Analog Display Screen Interface, also referred to as Analog Display Services Interface) that offers some of the characteristics of this patent application by presenting visual information on a user phone with a display screen. ADSI is a simplistic messaging technology of modest success, which is an outgrowth of Caller-ID. ADSI is a superset of the Automatic Number Identification (ANI) protocol used by Caller-ID and Call Waiting-ID. The terminology ADSI is used generally herein to encompass ADSI, ANI, Caller-ID, and Call Waiting-ID. ADSI offers interruptive data transmission on analog telephone lines. The data transmission is conducted at a low speed data rate using standard 1200 baud (1200 bits per second—bps) modem technology. Like all modems, it uses the voiceband frequency range allocated for phone lines, and so either a voice communication can be taking place, or data transmission can be taking place, but not both at the same time since the data travels over the same communications channel and in the same frequency range as the voice communications (referred to as In-Band Signaling). Thus, the communications channel can carry either voice or ADSI data at any given moment, but not both simultaneously (referred to as alternate voice/data).

The diagram of FIG. 1 depicts the ADSI environment of a telephone central office with analog phones, ADSI screen phones, a service provider computer, and the associated ADSI modems and ADSI adjunct processor for delivering Caller-ID and Call Waiting-ID. Referring to FIG. 1, there is a telephone central office 10 incorporating a switching system 12, and an ADSI Caller-ID and Call Waiting-ID adjunct processor 14. Switching system 12 provides phone service on analog phone lines 16, which terminate in analog phones 18, ADSI screen phones 22, and a service provider computer 26. ADSI screen phones 22 incorporate a subscriber version of an ADSI modem (not shown), similar to the stand-alone ADSI modem 24 connected to the service provider computer 26. There also are central office versions of ADSI modems 20 which are connected to the subscriber phone lines 16 and to the ADSI adjunct processor 14.

ADSI can be configured in two physical arrangements which are illustrated in FIG. 1. In both those arrangements the user's display screen phone 22 incorporates a 1200 baud modem. In one of those arrangements there is a companion 1200 baud modem 20 at the telephone company (telco) central office to send data to the user's display phone. This arrangement is commonly used by the telco to deliver Caller-ID and Call Waiting-ID, notifying the called party of the phone number (and sometimes the name) of the caller. In the case of Caller-ID, the telco central office system delivers the information during the ringing cycle, before the call has been connected. Consider screen phone labeled “A” and its associated analog phone line. In the idle state, meaning, in the absence of telco switch 12 creating a connection between it and another phone line, phone A is not connected to anything other than the switch 12 and the adjunct processor 14. Now assume that there is an incoming call from analog phone B. The steps of this process are: (i) B dials the phone number for A; (ii) switch 12 tests to see if line A is idle; (iii) if line A is idle, switch 12 applies ringing current to it; (iv) between the first and second ring cycle, the adjunct processor 14 directs the telco ADSI modem 20 to interrupt the analog connection to the switch 12, and then to send the Caller-ID data to screen phone A; (v) screen phone A continues to ring until the user answers or caller B hangs up.

In the case of Call Waiting-ID, telco switch 12 interrupts a call in progress to deliver the Call Waiting information. From the above example, if the user at A answers the phone, switch 12 physically connects the phone line for A to the phone line for B. If during the duration of this call there is another incoming call for A, the adjunct processor 14 directs the telco ADSI modem 20 for A to interrupt the analog connection to the switch 12, and then to send the Call Waiting-ID data to screen phone A. Obviously then, the connection between A and B is also interrupted during this Call Waiting-ID transaction.

Only the telco serving central office can send data to an ADSI phone before or during a call in this fashion because of the unique physical connection of the telco ADSI modem to the user's phone line. In the absence of a call, no other system is connected to the user's phone line except for the telco central office, and thus there is no possible means for any other system to communicate with the user's ADSI modem. During a call there is a physical connection between the user's phone line and one other phone line, and, similarly, no means is available for any other system to interject itself into that connection to communicate with the user's ADSI modem. In these circumstances, the telco and only the telco can communicate with the user's ADSI modem because the Telco's modem is positioned in series with the user's phone line such that, when the telco modem is activated by the telco central office, the modem interrupts the voice connection path (which is also the ringing path) to transmit the Caller ID or Call Waiting-ID data.

In the other ADSI arrangement, there is a companion 1200 baud modem 24 at a service provider, such as a bank which delivers services via a computer system 26. In this arrangement the service provider offers functions such as online information access to dial-in users via a system of interactive menu items. Users such as A dial in to a specified phone number of the service provider, whereupon the call is answered by the service provider's modem 24. The online information transaction occurs during the duration of this call, during which time neither the user's phone (or phone line) nor the phone line of the service provider can be used for any other purpose. As in the call from B to A, there now is a physical connection created by the telco switch 12 between user phone A and the service provider's phone line, and no means is available for any other system to interject itself into that connection to communicate with user A's ADSI modem or screen phone.

In another aspect of operation, ADSI has been proposed as a means of providing a subscriber with an ADSI screen phone the ability to control or administer certain telco central office features. For example, the screen phone might display the status of Call Forwarding on demand, along with the phone number that forwarded calls would be directed to.

ADSI offers only limited capability of providing an Interactive Device Control System. It operates at very low speed, thus limiting its utility in the nature of messages it can communicate. The only conditions under which an ADSI display phone is capable of receiving ADSI messages are: from the telco central office (whether the display phone is off line or on a call), or from another ADSI modem when the display phone is directly dialed up to that other modem. So, for example, if an ADSI screen phone were on a dialed up connection, it could not exchange ADSI messages with any devices other than the dialed device or the serving telco CO. And, since it only operates on analog phone lines, ADSI is not capable of communicating with Internet devices. Thus it is clear that ADSI does not serve as a general purpose Interactive Device Control System.

Internet Telephony (also called IP Telephony or VoIP) incorporates a capability for certain visual controls over calls and communications devices. Of particular interest is the International Telecommunications Union (ITU) H.323 standard for multimedia communications over a network without a guaranteed Quality of Service (e.g. a LAN or the Internet). ANNEX K of H.323 sets forth procedures for using HTML and http to communicate messages to a caller enabling the caller to invoke “services” such as transferring the call. Services defined by ANNEX K are in two classes: not associated with a call; and associated with a call. Services not associated with a call refer to the Registration process wherein users identify themselves to the network. Services associated with a call enable a caller to effect control of the called system to take an action such as transferring the call to voice mail. In this service transaction, an http server associated with a called device (which could simply be an http process running on the user's PC) would send a web page with menus and controls to the caller, inviting the caller to invoke one of the listed actions. Caller activation of one of the menu items sends a response message to the http server indicating the caller's choice. The http server associated with the called device sends an appropriate message (normally an H.225.0 call signaling message referencing the callIdentifier for the call) to the called party's Gateway to initiate the call transfer. The Gateway then implements the requested action. H.323 utilizes Gateways and Gateway Controllers, according to the associated H.248 (MegaCO) standard. A Gateway typically is a software application running on a server, perhaps providing VoIP services for PCs on a corporate LAN. A Gateway arrangement, perhaps provided by a VoIP vendor, may have trunking connections to the PSTN to accommodate traffic originating or terminating on the PSTN but carried across the Internet (i.e., VoIP). Gateways establish and maintain the media connection across the Internet for the end devices. A media connection is assigned a unique “callIdentifier”.

An example of the H.323 Gateway arrangement for managing call control is illustrated in FIG. 2. The Internet is shown stylistically as 60 and the PSTN as 70. The PSTN is comprised of telco Central Offices 10 incorporating switching systems 12 which provide analog phone lines 16 to telephones 18. Switching systems are interconnected to each other and to the PSTN in general via multiplexed trunks 54 and SS7 messaging links 52. PCs 72 reside on LANs 74 having high speed access links 62 to the Internet 60. H.323 Gateways are shown as 76. Gateway #1 is resident on a LAN, and Gateway #2 connects to the Internet 60 via access link 62, and has a trunking interface to a PSTN central office via multiplexed trunks 54. Presume that Gateway #2 provides VoIP services for PC “M”, and Gateway #1 provides the same services for PCs “N” and “P”. If a call were establishment from M to N, Gateways #1 and #2 would maintain control of the call, which would have an assigned callIdentifier. If N wished to transfer the call to P, it would send an appropriate message (an H.225.0 message referencing the callIdentifier) to its controlling Gateway (Gateway #2) requesting the transfer. Gateway #2 would then effect the transfer, dropping the connection to N and establishing a connection to P. If the call transfer were occasioned by M receiving a web page from N, offering a call transfer to P, the operation would be identical except for the addition of an http server process running on N which interprets the user response (from M) and directly or indirectly initiates the H.225.0 message to Gateway #1.

H.323 ANNEX K provides a simple and well known methodology for implementing elegant and very desirable device control services in the Internet telephony realm. However, those services only extend to IP Telephony calls associated with an H.323/H.248 Gateway; those services are unavailable in a non-VoIP environment wherein the PSTN maintains and manages call control for PSTN and Internet connections through PSTN elements such as telco central office switching systems, PBXs, and the like.

Because of these voids, there remains a need in the art for a method and means for an Interactive Device Control System to provide users with greater control over call handling devices, and to further promote the integration of the Internet with the PSTN.

### SUMMARY OF THE INVENTION

The present invention provides an Interactive Device Control System having a method and means for providing device control, call control, and communications system information for telecommunications and Internet voice and multimedia communications. Several co-pending patent applications of the same inventor provide for the integration of the Internet with the Public Switched Telephone Network (PSTN) in various aspects, including a method and means for enabling a calling device to create an Internet communication with another device simply by dialing its telephone number. One benefit of such integration is that traditional voice-only telephone calls can be augmented or replaced with multimedia communications using Internet protocols and capabilities. Such multimedia communications may include: voice and other audio; graphics, images and other visual material; motion video; and synchronized audio and video transmitted together including TV video and videophone service. The data for these multimedia communications may be transmitted on the Internet as a result of the integration described therein, while, optionally, the voice portion of a multimedia communication may be transmitted over the PSTN for improved audio quality. The enhanced capabilities provided by the present invention further facilitate that integration by enabling a call dialed on the PSTN to provide device control, call control, and communications system information with the associated data and messaging communications transpiring over either the PSTN or the Internet.

Certain enhancements over the co-pending patent applications are herein described. The current invention provides the ability for a device or system such as an automated attendant system mentioned in a previous example to present a caller using a screen phone with a visually displayed menu of options, which may appear as screen buttons. Caller activation of an option, such as by pressing a touch screen button, causes a response message to be sent to the device or system providing the menu of options. Upon receipt of the response message, the device or system effects the action associated with the screen button. If the action is a call control action such as transferring the call, the device or system will send an appropriate call control message to its serving PSTN entity, having responsibility for call control, which will then execute the desired action.

The controlling capability is offered to the user of the remote device by the presentation on a user's screen of device control display elements such as screen buttons or user prompts, accompanied by any associated information or user instructions. The communications system offers this controlling capability to the user of the remote device by sending a message to the remote device comprising information to be presented on the user's display screen, along with any necessary formatting instructions to influence the appearance of the presented information, to enable the selection of presentation elements by the user, and to enable responses to selectable presentation elements. While other technologies, including technologies yet to be defined, may be as suitable or more suitable, the current Internet technologies of HTML (HyperText Markup Language) and http (hypertext transfer protocol) are suitable as languages for expressing presentation information and generating responses to selectable presentation elements, as required by this invention. In essence, the called device sends a web page to the caller. In that respect, the presentation aspect of this arrangement could be consider as a client “browser” in the user's phone that communicates with a “server” in the communications device via Interactive Device Control System messages of this invention.

A caller's screen phone may be touch enabled or voice responsive, so that the caller need only touch a screen button or speak a reply to respond to the options presented by the automated attendant system. A caller can thus interactively control a communications device (e.g., the automated attendant system) to control or influence the processing of a call. In this arrangement, a call answered by an automated attendant system will present the caller with a displayed menu of options with each option being associated with a screen button (perhaps button 1 is Service Department, button 2 is Sales Department, button 3 is Accounting Department, and so on). Each screen button has an associated response message which directly or indirectly instructs the PSTN call controlling entity of the desired disposition of the call. As a result of the caller pressing the associated screen button the call will be transferred to the listed department by the automated attendant system and the action of the response message.

Displayed menu items may have multiple levels or tiers wherein a user response to a menu item may generate the presentation of sub-menu items, and so on until the user's interactive device control task is completed. Additionally, the call control function can be indirect by the presentation of information only, without the presentation of selectable options. For example, a user device calling a communication system might result in the communications system sending the message “Out to Lunch—call back after 2:00” for presentation on the calling device. Such a user message could be associated with a call control message to the called device's serving PSTN element terminating the call.

Co-pending patent applications describe an arrangement wherein an Internet communication is established by one device dialing the telephone number of another device on the PSTN. This invention provides a more detailed specification of that arrangement by defining an operating environment for integrated Internet and PSTN communications in which the PSTN maintains control and management of calls, including those calls that result in an Internet communication. The term “PSTN” as used in this sense includes not only local and long distance telco switching systems and their support systems, and interface systems such as those for DSL and cable-TV access, but also includes subscriber-provided ancillary systems such as PBXs and adjunct devices such as Voice Mail Systems (VMS) and Automated Attendant systems. User devices particularly include display phones configured as Integrated Devices. As defined in the co-pending patent applications, an Integrated Device is capable of establishing an Internet communication with another Integrated Device by dialing its phone number on the PSTN. An Integrated Device has an Internet connection with an IP address, a telephony connection with a telephone number, and supports digital message communications such as ISDN for call management (signaling). The messaging communications encompasses messages as are necessary to establish, tear down, transfer, and otherwise manage all aspects of call control for both PSTN and Internet aspects of the communication.

To illustrate the present invention of PSTN call control, presume that one Integrated Device has dialed another, resulting in an Internet communication between the two devices. In general terms, this is accomplished by the PSTN (central office switches, for example) obtaining the IP address of the calling or called device, and providing that address to the other device via the call management messaging system. Once one device has the IP address of the other, an Internet communication may commence.

In this environment, device control messages and responses between calling and called systems may transit either the Internet or the PSTN. Call management events during an Internet communication, such as disconnecting or transferring the call, are accomplished by either of the two devices sending a call management message to its serving PSTN entity (e.g., the local central office switch, PBX, etc.). Assuming that the PSTN entity has Internet connectivity, these call management messages also may transit either the Internet or the PSTN. The PSTN then tears down or transfers the call as instructed. A call transfer to another Integrated Device would be handled in a similar fashion to the call setup process, and thus another Internet communication could result from a call transfer. The PSTN may assign a call-ID or context or Session ID to a call in order to facilitate the control function; in that circumstance, call control messages from a device to the PSTN, or the reverse, would appropriately reference the call identifier. Intermediate networks, such as that of traditional long distance carriers, may also participate in these communications, and are enabled to establish, transfer, and disconnect Internet and mixed mode Internet-PSTN calls via appropriate call control messages from the originating or terminating devices or Central Office systems.

There are a number of advantages from this arrangement in which the PSTN maintains call management. The audio portion of a call can transit the PSTN, while visual aspects transit the Internet, thus avoiding problems associated with audio on the Internet due to congestion, dropped packets, and so on. In such a bifurcated call, users could turn on or off videophone service as they wished without losing or affecting their voice communication. Calls can be completed and transferred regardless of the nature and capabilities of the terminal device—whether it is an analog phone or an Integrated Device, the PSTN manages the connection seamlessly, and a call can be transferred from analog to multimedia or the reverse. In a transfer from analog to multimedia, the multimedia Internet capabilities will be automatically engaged. The common carriers can move into Internet Telephony to take advantage of the Internet's multimedia capabilities while preserving their infrastructure investments in plant (switching systems, SS7, etc.) and in software systems (OSS, Provisioning, Billing, and so on). Furthermore, this arrangement enables traditional long distance carriers to participate in providing mixed-mode and Internet long distance services.

The call management aspects of the present invention distinguish the device control aspects of the present invention from that of H.323 with regard to device control actions that affect calls. Recall that H.323 utilizes a Gateway to manage calls, and device control messages for call management functions are sent to the Gateway for execution. In the present invention, PSTN elements manage calls, and device control messages for call management functions are sent to the device's serving PSTN element for execution.

This patent application also presents innovations in the control of communications devices via the previously described web page arrangement. HTML and http are well known, and H.323 ANNEX K proposes their use as a generic utility for caller control of a communications device. However, this patent application identifies specific, unique and hitherto unknown features and operations that are implemented with the web page model, and the applicant proposes that these unique features, even though implemented with a standard tool kit, still represent advances in the state of the art and are therefore novel and patentable.

There are a wide variety of communications devices, services, and systems subject to the matter of this invention. These include facilities typically associated with an operating telephone company (telco) such as: telephone central office systems; telephone central office system interface devices, such as those providing DSL access, cable-TV access, or fixed or cellular wireless access, which provide telephony and Internet services for client devices; telephone long distance central office systems; telephone central office billing systems; and, telephone central office service ordering systems. The term “telephone central office system” should be understood to include switching systems and various adjunct and support systems. The communications devices, services, and systems subject to the matter of this invention also include: office telephone systems such as PBXs and Key Systems; adjunct devices such as automated attendant systems, voice mail systems, automatic call distributor systems, and the like; facsimile machines; wireless communications devices such as a cellular phone having a display screen; terminal devices such as telephones having a display screen; Internet communications devices such as Personal Computers (PC's) and servers; and Integrated Devices having a display screen.

Communications devices, services, and systems such as those in the aforementioned list provide the ability for their function or operation to be interactively controlled by a remote user via the user's device, which is nominally a version of a display phone. Typically an exchange begins with one user device calling another by issuing a call setup request message. One or more communications systems commonly reside in the path between a calling and a called device. Any such communications system in the chain of systems receiving and processing a call setup request message may respond directly to the calling device by offering the user of the calling device the opportunity to influence the processing of the call.

The communications system offers the remote user control over selected functions by the presentation of screen buttons or similar selectable response elements. The user's system and the displayed response elements are arranged so that the user can respond to the remote system with any human-machine interactive means such as by touch entry on the screen, pressing pre-configured physical or dynamically programmable “soft keys”, by a voice response, by the use of keys on a keyboard, or pressing dial pad buttons. Alternatively, the user device may be arranged to respond automatically on behalf of the user.

The functions or operations that are interactively controlled include: call initiation; control of a call in progress (call transfer or disconnection, etc.); control of a communications system such as an automated attendant system; providing dynamic communications system information such as the status of Call Forwarding for a particular phone number; control of communications system parameters defining how the system handles calls or features, such as administering Call Forwarding; administering communications subscription services; and activating communications system functions related to a call, such as Call Trace, Repeat Call, and the like. The preceding list is suggestive of the communications functions and methods of operation enabled by this invention. In some environments, these capabilities can take place in the absence of an associated telephone call. For example, a user display phone might interact with its associated serving system such as a telco central office to view or administer Call Forwarding, to subscribe to features such as Speed Call or a custom package of features, to obtain help with the operation of features (“how does Repeat Call work?”), and so on. In such an arrangement, the serving system might present a menu item, button, or icon on the user's device that will initiate an appropriate sequence of dialogs.

In aspects of this invention, the Internet is utilized for communicating these messages to Internet connected systems and devices, and the PSTN SS7 network or ISDN capability is utilized for communicating these messages to PSTN connected systems and devices. In still another aspect of this invention device control and call control messages are transmitted across the Internet, the PSTN, or across any other medium such as a wireless arrangement, between communications systems and user devices operable with this invention.

There are several possible messaging systems that the PSTN might use for these purposes. The messaging communications extends directly or indirectly to one or the other or both of the calling and called devices and to their serving systems. The worldwide PSTN has the SS7 messaging system interconnecting all the major switching centers. Telephone companies will likely use SS7 and ISDN. As another possibility, the PSTN might have Internet access in order to communicate via Internet messages with the calling or called device, switching system interface devices, or other central office switching systems. Further, the PSTN might use a mix of technologies, for example, SS7 might be used from one C.O. to another, but ISDN might be used to communicate the same information to the terminal (user) device. Since multiple workable arrangements are possible, it is only required that there is a method of sending appropriate messages to devices and systems for engaging in interactive device control operations.

In a variation of the device control arrangement, a display phone such as an Integrated Device may receive a call setup request message from another device, such as another Integrated Device. In this circumstance, the called Integrated Device may respond to the call setup request message with a displayable menu presentation of call control options, such as offering the caller to have the call forwarded to another number or person, or to direct the call to the called party's voice mail system. In this circumstance the called Integrated Device operates as a communications system.

In another variation of this invention, a display phone such as an Integrated Device may send a message requesting control of a communications system, such as another Integrated Device, in lieu of sending a call setup request message to that device. For example, an Integrated Device suitably equipped with software for presenting an “information call” screen button to the user may, upon the user entering a called telephone number and the activating the “information call” button, send a message to the called device requesting that the called device respond with whatever information and control functions that it has available to present to callers. If the called device is associated with a business, the information offered might include the name of the business, the nature of the business, hours of operation, the address and a location map, and so forth. Control functions that are offered might include selecting a person or department from a menu list for creating a voice or multimedia connection, or selecting to route the incoming call to the called party's voice mail system. Therefore the Interactive Device Control System response from the called device would create a screen presentation on the caller's device of the above information, with button selections for the control functions if any are offered. The calling user could then review the presented information and select one of the available control functions; or, if the information satisfied the caller's needs (e.g., the caller just wanted to know the hours of operation), the caller could simply close the “window”. In a practical arrangement, an “information call” would create a data only call that would not ring the called phone or device, but the calling device would offer the user the option to press a screen button to cause the called phone to ring to engage in a voice conversation.

Distinguishing the present invention from ADSI, the Interactive Device Control System supports multiple simultaneous messaging communications between multiple compatible communications systems, services, or devices. The messaging system conveying the Interactive Device Control System messages provides an “Out Of Band Signaling” arrangement (OOBS), in which the transport of messages between systems does not interfere with the voice or multimedia communications path, and in which messaging can take place concurrently with voice or multimedia communications (referred to as “simultaneous voice/data”), with other messaging sessions, or concurrently with both voice or multimedia communications and other messaging sessions. Among other possibilities, the messaging capabilities provided by the Internet Protocol and ISDN satisfy this requirement.

As stated previously, one or more communications systems commonly reside in the path between a calling and a called device. Any such communications system in the chain of systems receiving and processing a call setup request message may respond directly to the calling device by offering the user of the calling device the opportunity to influence the processing of the call. In addition, multiple communications systems in the chain may respond to the same call setup request, as appropriate to the call. For example, presume that a hotel guest is using a hotel display phone compliant with this invention. Also presume that the hotel phone operates off a hotel PBX, and that the hotel PBX is connected to its serving telco central office system, and the telco central office system is connected to a long distance provider's toll central office system, all of which similarly comply with this invention. In this example the hotel phone has a startup presentation provided by the hotel PBX offering basic communications services of common interest to guests such as screen buttons to call the front desk, to order room service, and to place an outside call. Pressing any of the screen buttons sends the appropriate response message to the hotel PBX, which processes the call request accordingly.

If the guest presses the screen button to place an outside call, either the hotel guest phone, or the hotel PBX on behalf of the guest phone, generates a call setup request message to the telco central office system, but without including a called telephone number in the message. (Although the system could certainly be configured to accept a telephone number up front, consider for this example that inputting a telephone number occurs at a later step.) The telco central office system responds to this call setup request message by sending an Interactive Device Control System message to the guest phone offering a set of functions and associated instructions. Those functions might offer a variety of billing arrangements (bill to the hotel, bill to a commercial credit card, bill to a telephone credit card, call collect, and so on), and might include options to place a local call or place a long distance call. Since there are many long distance carriers, the menu of functions might include screen buttons for the more commonly used long distance carriers. If the guest presses the screen button for one of those carriers, AT&T for example, the telco central office system will forward the call setup request message to AT&T's long distance central office on behalf of the hotel phone, again without a called telephone number in the message. In response to this call setup request message, the AT&T central office will send an Interactive Device Control System message to the hotel phone offering a set of functions and associated instructions. The menu of functions from AT&T might ask for the telephone number to be called, a credit card number, and so on. User response to an item on a menu might cause another menu to be presented, until the user's call is placed.

If the called number is busy or if no one answers, AT&T might offer its voice mail service to the hotel guest, again, via a display screen presentation. This service allows a caller to dictate a message that is recorded by the AT&T system. The AT&T system attempts to call the called number every half hour for up to 12 hours. If someone answers on one of these call attempts, the AT&T system plays the recorded message. The AT&T voice mail service is provided for a fee. The menu presentation by AT&T for the hotel guest presumably would inform the guest of the charges (e.g., “Voice Mail Service—$2”), but regardless of whether it does or not, the Interactive Device Control System incorporates the ability to communicate billing messages between systems for functions which have monetary costs associated, whether the cost is for a one-time usage or some other arrangement such as a subscription to a service. In the hotel guest scenario, the one-time fee presumably would be charged to directly or indirectly to the hotel guest.

Even after a call is in progress, the AT&T central office system might keep itself active in the call. For example, it might send information to the user on minutes of usage or the ongoing cost of the call, and so on. It might a present a screen button offering the ability for the user to create a three-way or multi-party conference call, or offer the ability to turn on or off videophone service during the course of the call. On completion of the call the AT&T system might offer the hotel guest the ability to place another call, sparing the user from cascading through the initial series of menus from the other systems.

This invention then, provides for a method and means for an Interactive Device Control System giving users of display phones the ability to influence and control communications systems functions such as the processing of voice and multimedia calls; the Interactive Device Control System extends to communications systems and devices on the Internet and on the PSTN, thus further promoting the integration of the Internet with the PSTN.

### BRIEF DESCRIPTION OF THE DRAWINGS

The invention will be more fully understood when reference is had to the following detailed description of the preferred embodiment of the invention and the accompanying drawings, in which:

FIG. 1 is a schematic illustration of the prior art ADSI arrangement;

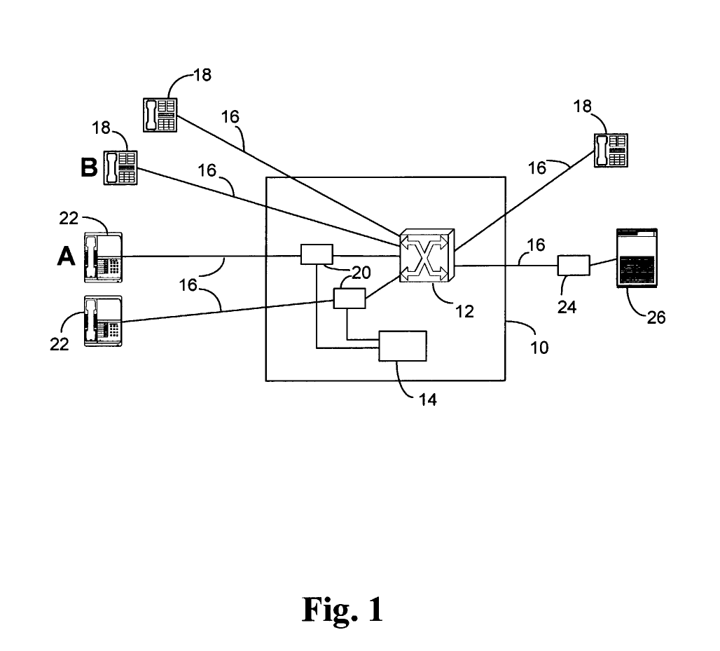

FIG. 2 is a schematic illustration of the prior art H.323 arrangement utilizing Gateways for call control;

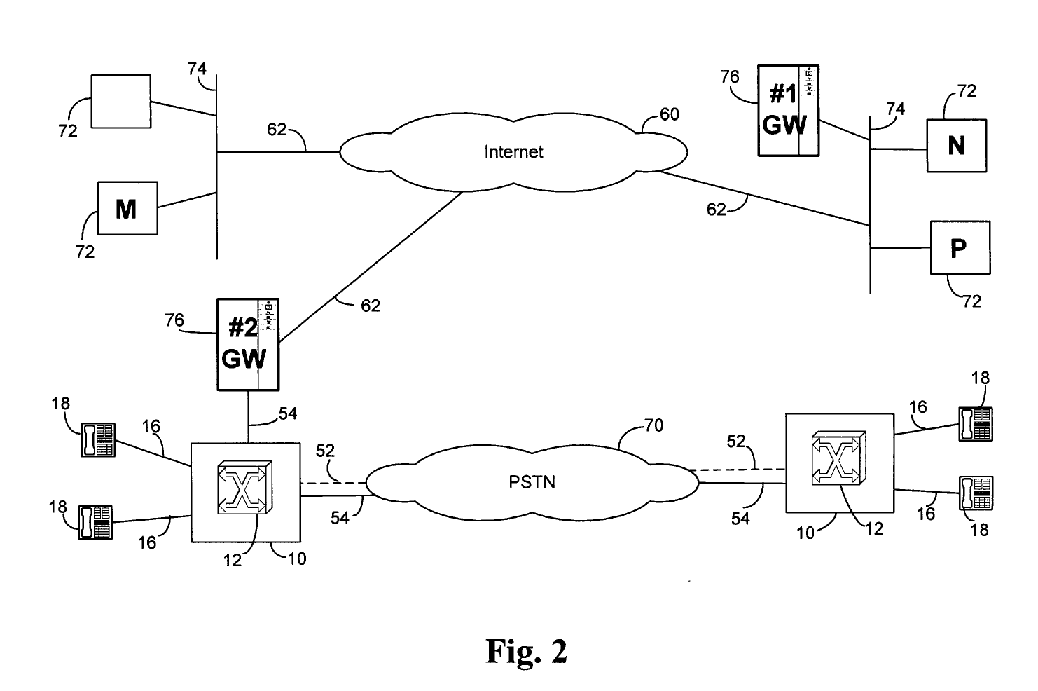

FIG. 3 is a schematic illustration of the general principle presented in this patent application in which the PSTN maintains call control for calls which result partially or completely in an Internet communication;

FIG. 4 is a schematic illustration of the general principals of the present invention showing a user display phone, a communications system, and a telephone central office system;

FIG. 5 depicts a networking environment of the Interactive Device Control System showing a user device and a communications system in an arrangement of local and long distance telephone central office systems; and

FIG. 6 extends the environment of FIG. 5 by adding the Internet, an Internet user device, and connectivity from the PSTN telephone central office systems to the Internet.

### DETAILED DESCRIPTION OF THE INVENTION

Described herein is an Interactive Device Control System operable on a wide variety of communications devices, systems, and services both on the PSTN and on the Internet. The purpose of the Interactive Device Control System is to provide an arrangement giving users greater control over call handling systems, and over the calls themselves, than is available with conventional systems, while promoting the integration of the Internet with the PSTN.

The present invention provides an Interactive Device Control System having a method and means for providing device control, call control, and communications system information for telecommunications and Internet voice and multimedia communications.

Co-pending patent applications provide a method and means for integrating the Internet with the Public Switched Telephone Network (PSTN); more specifically, they enable a calling device to establish an Internet communication with a called device simply by dialing its telephone number. One benefit of such integration is that traditional voice-only telephone calls can be augmented or replaced with multimedia communications using Internet protocols and capabilities. Such multimedia communications may include: voice and other audio; graphics, images and other visual material; motion video; and synchronized audio and video transmitted together including TV video and videophone service. The data for these multimedia communications may be transmitted on the Internet as a result of the integration described therein.

The co-pending patent applications describe various aspects of this integration; the enhanced capabilities provided by the present invention facilitate that integration. The following provides an overview of the co-pending patent applications.

Co-pending patent application entitled “Integrated Device For Integrating The Internet With The Public Switched Telephone Network”, Serial No. 60/301,756, Docket No. 0054-3, describes “Integrated Devices”, for integrating the Internet with the PSTN, which have an Internet connection with an associated IP address, a PSTN connection with an associated telephone number, and a digital messaging connection to the PSTN for conveying call management messages to include messages containing telephone numbers and IP addresses.

Co-pending application entitled “Integrating the Internet with the Public Switched Telephone Network”, Serial No. 60/301,757, Docket No. 0054-4, describes an enhanced communications environment in which a telephone call placed to an Integrated Device creates end-to-end communications over the Internet rather than over the PSTN.

There exists a class of devices, such as those for Voice over IP, DSL, cable TV, fixed wireless, Internet capable wireless cellular, and similar distribution systems, which provide Internet and telephony services to client devices, such as phones and PCs, by providing an interface to the telephone company central office switching system. Co-pending application entitled “Telephone Central Office Switch Interface With Messaging Channel For Integrating The PSTN With The Internet”, Serial No. 60/301,758, Attorney Docket No. 0054-5, discloses a method and means for providing specific messaging capabilities between a telephone central office switching system and this class of interface device, enabling the integration of the Internet with the PSTN. The communications link carries call setup, telephone number, and IP address messages to and from the switching system and to and from the client devices of the interface device.

Co-pending patent application entitled “Telephone Switching System For Integrating The Internet With The Public Switched Telephone Network”, Serial No. 60/306,294, Attorney Docket No. 0054-7, discloses a method and means for a telephone central office switching system to enable a calling device to establish an Internet communication with a called device by dialing its telephone number.

Co-pending patent application entitled “Integrated Telephone Central Office Systems For Integrating The Internet With The Public Switched Telephone Network”, Serial No. 60/306,293, Attorney Docket No. 0054-8, discloses an integrated assembly of telephone central office switching system integrated interface devices, comprising telephone central office switching systems, and switching system interface devices such as those for providing DSL service, Voice over IP (VoIP) service, cable modem service, fixed wireless service, and Internet capable cellular wireless service. The integrated telephone central office systems therein described offers efficiencies and economies further benefiting the integration of the Internet with the PSTN.

Co-pending patent application entitled “Call Management Messaging System For Integrating The Internet With The Public Switched Telephone Network”, Serial No. 60/311,401, Attorney Docket No. 0054-9, discloses a messaging system for communicating call management messages among communications devices connected to the Internet and to the PSTN. Call management messages include call setup request messages, call acceptance messages, call rejection messages, call forwarding messages and the like. The call management messaging system operates seamlessly across both the Internet and the PSTN, thus providing further integration of those two networks.

Co-pending patent application entitled “Stored Profile System For Storing And Exchanging User And System Communications Profiles To Integrate The Internet With The Public Switched Telephone Network”, Serial No. 60/317,057, Attorney Docket No. 0054-12, discloses a system for the PSTN and the Internet to maintain and exchange communications related information such as personal contact information and preferences. The Stored Profile System enables users to exchange contact information such as Electronic Business Cards as a part of call setup, operating like an enhanced Caller-ID, and enables the calling party to select from available options offered by the called party's system for communicating with the called party. The stored profiles capability extends to communications systems on both the PSTN and the Internet, thus further promoting the integration of the Internet with the PSTN.

The co-pending applications described hereinabove provide reference information useful in developing a full understanding of the present invention as it relates to these systems and devices. Accordingly, the disclosure of each aforementioned co-pending application is incorporated herein by specific reference thereto.

Certain enhancements over the co-pending patent applications are herein described.

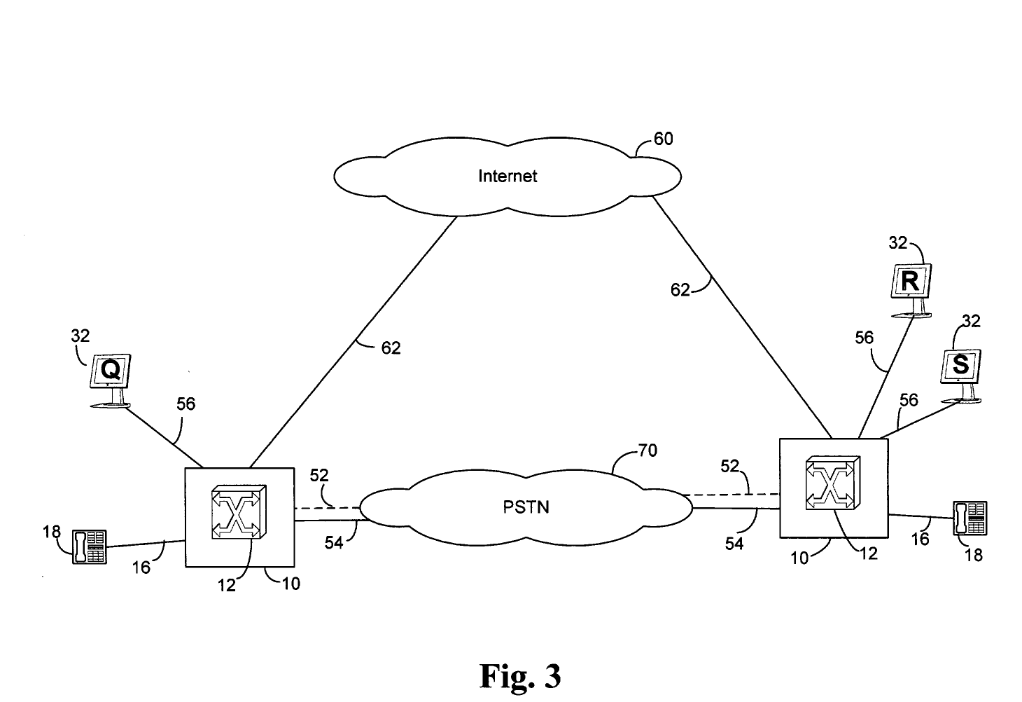

FIG. 3 is a schematic illustration of the general principle presented in this patent application in which the PSTN maintains call control for calls which result partially or completely in an Internet communication. The Internet is shown stylistically as 60 and the PSTN as 70. The PSTN is comprised of telco Central Offices 10 incorporating switching systems 12 which provide analog phone lines 16 to telephones 18. Switching systems are interconnected to each other and to the PSTN in general via multiplexed trunks 54 and SS7 messaging links 52. Central Offices 10 have high speed access links 62 to the Internet. User screen phones 32 connect to the telco Central Offices 10 via high speed multiplexed communications links 56 such as might be provided by DSL or cable-TV access arrangements. Communications links 56 carry digitized voice, images, videophone, and other multimedia data (media), as well as a PSTN messaging communications such as ISDN (signaling). For this arrangement, the spectrum of ISDN messages would be extended to accommodate the additional functionality, and the ISDN transmission scheme would be properly reformatted from baseband transmission to a packetized format compatible with the transmission scheme of the communications link 56. Central Office 10 incorporates a router function (not shown) which directs multiplexed data on communications link 56 to the proper destinations: Internet data to and from the Internet; telephone audio to and from the Central Office switch; and PSTN messaging data to and from the Central Office switch and SS7 network. Internet data can be associated with or independent of a multimedia telephone call (i.e., traditional Internet web-based traffic).

An example of the operation of this arrangement is follows, beginning with a discussion of the Internet call setup process. User device Q dials the telephone number of R. The PSTN, via one of several possible methods as described in the co-pending patent applications, obtains the IP address of at least one of Q or R, and delivers it to the other via the messaging capability 52 of the PSTN, and via the multiplexed communications links 56 connecting to the user devices. For simplicity of discussion, assume the serving Central Office for the calling device Q provides Q with the IP address of called device R. Device Q now having the IP address of the R, sends R an Internet message addressed to R's IP address, requesting an Internet communication. Every Internet message is an IP packet which includes both the source address and the destination address. Therefore, when the addressed device R receives the Internet message, it now also has the IP address of Q. The two devices are then enabled to conduct any or all aspects of the resulting communication across the Internet. For audio quality purposes, the audio portion may transit the PSTN as a standard telephone call, while images, video, and other data transit the Internet. Internet data transmitted between Q and R as a result of this call establishment transits multiplexed communications links 56 to the telco Central Office 10 and from there is routed across Internet access links 62 to the Internet, with data in the reverse direction following the opposite sequence.

Now that an Internet call has been established between Q and R, the user at R wishes to transfer the call to S and initiates the call transfer by popping up a “call transfer” window and entering the telephone number for S. In response to the user action, user device R then sends a call control signaling message to its serving Central Office 10 via the multiplexed communications link 56. Following the same scheme as employed in the initial call setup process, Central Office 10 (or some other element of the PSTN) obtains the IP address of S and sends it to Q. Device Q then repeats the process of establishing an Internet communication, now with S. The serving Central Office for R sends R a disconnect message and R drops all connections related to the transferred call. An Internet call is now established between Q and S, with the PSTN maintaining call control.

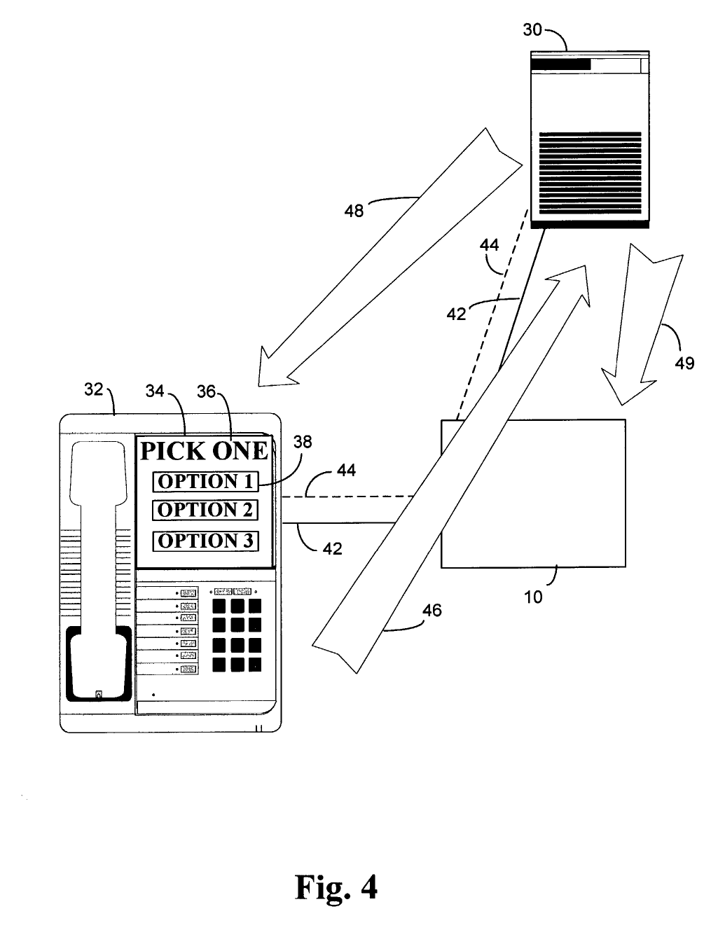

FIG. 4 is a schematic illustration of the current invention showing a communications system presenting a visually displayed menu of options on a user device such as a screen phone. Referring to FIG. 4, there is a communications system 30, such as an automated attendant system, and a user display phone 32 having display screen 34. Display screen 34 has presented on it a “window” 36 containing information and selectable menu options 38 sent from communications system 30. Selectable menu options 38 are presented as screen buttons; display screen 34 optionally is touch enabled such that a user touch of a screen button 38 generates a response from the user device 32 to communications system 30. Both communications system 30 and user device 32 have voice and multimedia communications connectivity 42, and messaging system connectivity 44 to carry communications and messaging data. As depicted in the illustration, both user device 32 and communications system 30 connect via 42 and 44 to a telco central office system 10, although other arrangements are possible including connecting across the Internet. In an Internet environment, 42 and 44 could be an Internet access line such as a T-1 line. Messaging system connectivity 44 carries Interactive Device Control System messages between corresponding systems. Voice and multimedia communications connectivity 42 and messaging system connectivity 44 may coexist on the same communications medium, and may extend between any number of intervening systems such as telco long distance central office systems, office telephone systems, and the like. Call management messages traverse the messaging system connectivity 44 for sending call management messages between systems, such as call setup request messages, call disconnect messages, Call Forwarding messages, and the like. Arrow 46 indicates the messaging path from the user device 32 to the communications system 30, and arrow 48 indicates the messaging path from the communications system 30 to the user device 32.

The presentation message sent by the communications system 30 includes information and one or more user selectable options which control or influence the communications functions of communications system 30. Each selectable option has a response message associated with it which will be sent to the communications system 30 upon its selection. Each such response message indicates to the communications system 30 the option that has been selected by the user of user device 32. Upon receipt of a response message, communications system 30 effects the function associated with the response message, such as to send another menu of options to the user, or to implement a communications function related to the call, such as forwarding the call to another telephone number. In call related functions such as the latter case, communications system 30 sends an appropriate call control message to telco central office system 10, as indicated by arrow 49, causing the telco central office to execute the requested call forwarding.

Although the figure depicts a user device 32 calling a communications system 30, the same process applies to circumstance wherein the called system is simply another user device such as display phone 32.

In another method of operation, a user device 32 sends an Interactive Device Control System message comprising a request for information (an “information call”) to a communications system in lieu of sending a call management messaging system message comprising a call setup request to that system. Communications system 30 responds to the information request message by sending an Interactive Device Control System message to user device 32 for presentation on the user device display screen. If communications system 30 is associated with a business establishment, it may respond with information (a web page) such as a location map or the hours of operation. An actual call has not been created, and no other action on the part of the caller is required. When a user requests an Information Call, the PSTN establishes an Internet communication between the calling and called devices in the same manner as it does for other Internet communications—that is, the PSTN obtains the IP address of one device and provides it to the other, whereupon the two devices may communicate across the Internet. In the circumstance of an Information Call the call establishment lacks persistence and is treated by the PSTN as simply sending a message. However, this web page, like any other, may have links to other informational resources available from the called system; for example, perhaps the call was to Staples Office Supply, and the information web page had links to Staples' online catalog.

In other circumstances, the web page provided to the caller in response to an Information Call may have control buttons that would initiate voice and multimedia communications. For example, perhaps the call was to a department store, and the returned web page included a listing of the major departments with control buttons for each. Selecting one of those options will establish a telephone or multimedia call to the designated department. Since no call has actually been established as of the receipt of the informational web page, activating one of these links simply acts to place a call to a pre-designated phone number, operating something like a speedcall button. In this circumstance, activating a response button causes the user device 32 to send a call setup request message to its serving PSTN entity.

Another arrangement can be described with reference to the same figure in which the user device 32 administers or is provided information about communications features from its serving Central Office 10. In this arrangement, the user device would be provided with an icon, menu item, or similar access method to send a message to the associated Central Office to initiate the dialog. Although other access methods are possible, the icon or menu item could be configured as a URL (Uniform Resource Locator) which will generate an associated http GET method. The message (which could be the http GET message) is sent to the Central Office across messaging communications link 44. Messaging communications link 44 is multiplexed and configured to convey a variety of message types. The administration messages to and from the Central Office constitute an Out Of Band Signaling (OOBS) arrangement, which does not interfere with the voiceband media path. The Central Office responds to the user-initiated dialog with a menu of information and control items related to the services provisioned or available to the subscriber. Such a menu might include information and controls such as: the status of Call Forwarding on all lines with that feature (i.e., forwarding is turned on or off); the target phone number for Call Forwarding for each line; a control to turn Call Forwarding on or off; a control to subscribe or unsubscribe to Call Forwarding for each line, and so on. Responses to controls related to subscription services not only activate or deactivate those features, but update the subscriber's account records and generate billing as appropriate.

The above capability also extends to applying Central Office features to individual calls. For example, if the Central Office detects that the user has dialed a number and gotten a busy or no answer, it may initiate a message to the caller offering the Repeat Call feature (which keeps trying to reach the called party for a certain period of time). Repeat Call is usually associated with a fee per occasion, and so the control provided to the user might specify the fee, and activation of the control by the user would render a charge to the user's account. Optionally, the user device may have a preset menu that includes Repeat Call as a standard item, and the user may initiate the Repeat Call function on any call by operation of the menu control. This capability also applies to calls in progress. For example, a user might be offered a control by the Central Office in conjunction with incoming calls to activate Call Trace or Call Block to manage undesirable or malicious calls. Activation of such a control during the course of the call by the user would generate a response message to the Central Office instructing it to take the desired action.

Continuing reference to the same figure may be used to illustrate specific device control features offering a caller control over the operations of a Voice Mail Service (VMS) system. Presume now that communications system 30 is a VMS system. User device 32 calls or is routed to VMS 30, and VMS 30 responds with a menu 36 of control items 38. The VMS offers the following specific device control options to the caller related to the caller leaving a message for the called party: Dictate a message; review your message; delete your message; assign a priority to your message. Furthermore, the VMS offers the caller a control to transfer the call to another party, perhaps by entering an extension number or choosing a name from a list, or to transfer to an attendant. Activation of any of these control items by the caller sends a response message to the VMS, causing it to effect the desired function on behalf of the caller. Additionally, the Voice Mail system offers control options relating to the nature of the caller's message, such as: “leave a voice only message”, “leave a videophone message”, “leave your Electronic Business Card”.

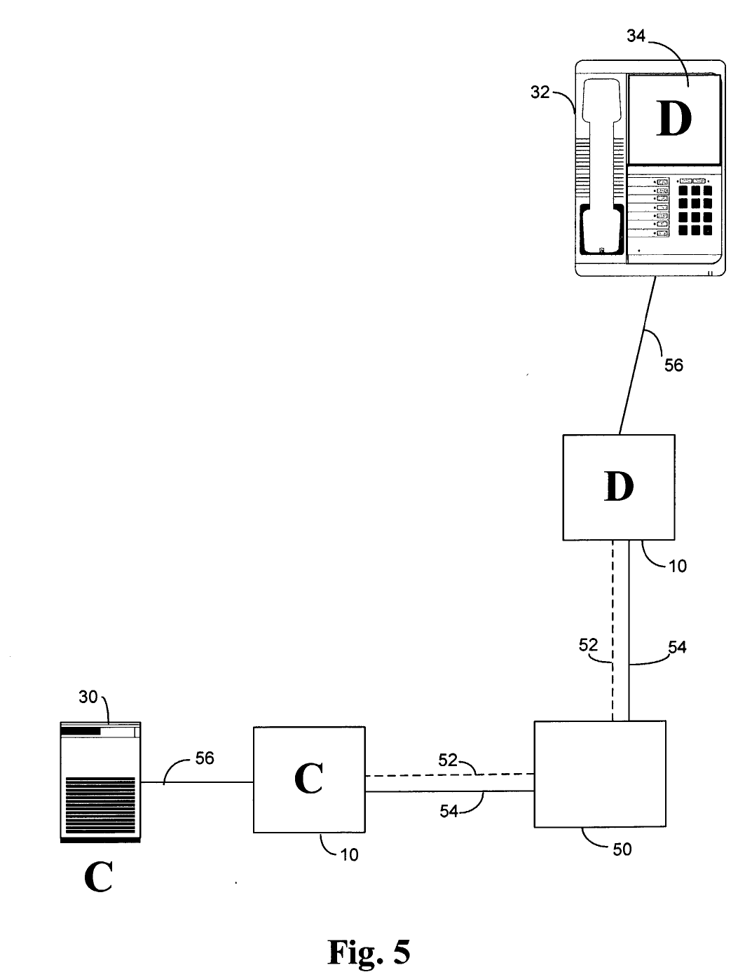

FIG. 5 depicts a networking environment of the Interactive Device Control System showing a user device and a communications system in an arrangement of local and long distance telco central office systems. Referring to FIG. 5, there is a user device 32 labeled “D” such as a display phone having display screen 34, a communications system 30 labeled “C”, such as a voice mail system, corresponding local serving telco central office systems 10, also labeled “D” and “C”, and long distance telco central office system 50. Interconnecting the local and long distance telco central office systems are communications links comprised of multiplexed trunks 54 and SS7 messaging links 52. Communications system 30 and user device 32 interconnect to their respective local telco central office system by multiplexed communications links 56, such as that provided by cable-TV distribution or DSL service, which provide a transport medium for packetized data. Multiplexed communications links 56 represent a composite of the messaging system connectivity 44 and voice and multimedia communications connectivity 42 shown in FIG. 4.

In one embodiment of this invention, Interactive Device Control System messages, call management system messages, and SS7 messages are formatted according to the Internet Protocols (IP). The arrangement as depicted presumes that the telco central office systems have been correspondingly enhanced according to the referenced co-pending patent applications to accommodate, route, and transmit IP formatted messaging data and packetized voice, as well as Internet data.

As an example of the operation of this arrangement, assume that user device D sends a call setup request message to communications system C. The call setup request message traverses communications link 56 to telco central office system D, which routes it to telco long distance central office system 50 via the SS7 messaging communications link 52, which in turn routes it on the SS7 messaging communications link 52 to telco central office system C, whereupon it traverses communications link 56 to communications system C. Communications system C responds to the call setup request message by sending a message to D for presentation on D's display screen, offering the user of D a selection of options for control of C's communications functions. The process continues as previously described, with a user selection of an option at D generating a response message to C indicating the selected option. Communications system C then effects whatever action is associated with the selected option. In the case of an action affecting the user's call, communications system C sends an appropriate call control message to its serving Central Office C to execute the call control function.

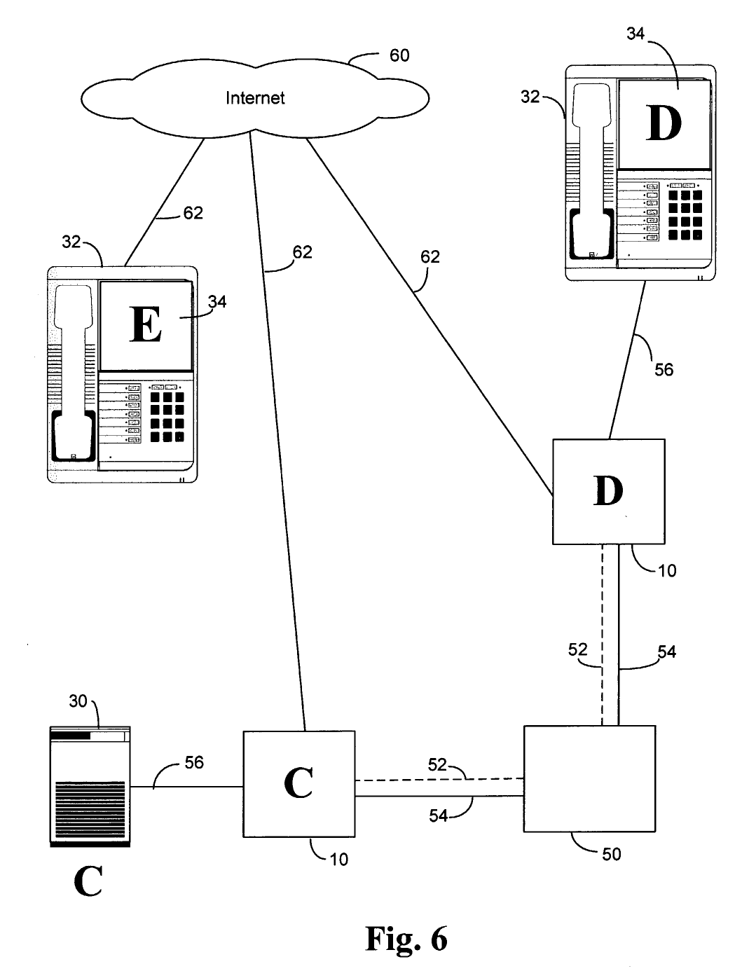

FIG. 6 extends the environment of FIG. 5 by adding the Internet 60, another user device 32 labeled “E”, having display screen 34, which is connected to the Internet with an access link 62, such as a T-1 line, capable of carrying packetized data, and similar access links 62 connecting to the local telco central offices C and D. Such access lines are capable of carrying multiple, simultaneous data communications sessions, and are suitable for carrying packetized call management messages and interactive device control messages as specified by this patent application, as well as packetized voice and multimedia communications. As an example of the operation of this arrangement, assume that user device E sends a call setup message in IP format to communications system C. The call setup message traverses the user's Internet access link 62, travels through the Internet, and traverses the Internet access link 62 to the telco central office system C, which routes it across communications link 56 to communications system C. Communications system C responds with an Interactive Device Control System message in IP format for presentation on E's display screen. The Interactive Device Control System message from C is routed to E along the reverse path of the original call setup request message. The interaction between C and E then continues as previously described, until C effects an action that completes the user transaction.

Another example will illustrate more clearly how the Interactive Device Control System further integrates the Internet with the PSTN. Assume for this example that device D and communications system C both have Internet connectivity and an IP address along with telephone connectivity and a telephone number. In addition, both are operable with a messaging system that enables a calling device to create an Internet communication with a called device simply by dialing its telephone number. These attributes identify both devices as Integrated Devices according to the definition provided in this document and the copending applications. The Internet connectivity, although not indicated separately, may be presumed to traverse communications links 56 and Internet access links 62. In this example, device D dials the telephone number of communications system C, thus generating a call setup request message which is received by the PSTN central office D serving device D. Utilizing any one of several possible methods of operation described in the co-pending patent applications, the PSTN obtains the IP address of at least one of the calling and called devices and provides it to the other via a suitable messaging arrangement. For purposes of this example, presume that the PSTN utilized the SS7 network 52 and multiplexed communications links 56 for this purpose, although it should be pointed out that the PSTN could utilize the Internet for this purpose as well. Communications system C, now having the IP address of the calling device D, sends Interactive Device Control System messages to D via the Internet, traversing communications links 56 and Internet access links 62. Device D then responds to system C via the Internet. This arrangement offers the benefit of constraining traffic on the SS7 network to those types of messages used for call setup and call management, and of carrying data traffic of a more general nature across the Internet.

This figure could also be used to generalize the concept advanced in this patent application of mid-stream systems providing device control options to the caller. Harkening back to the hotel example advanced previously, presume that user device D is a hotel phone calling long distance to communications system C. As the call setup request message transits the network from D to C, intervening systems such as the long distance Central Office 50 may initiate control dialogs to the calling user in order to complete the call (e.g., asking for a credit card number), or to offer services (e.g., the AT&T Voice Mail service) or information (ongoing time and charges). As suggested previously, the control actions of the long distance Central Office may persist for the duration of the call, and may even extend beyond the termination of the call.

As just described, the Internet and the PSTN comprise a seamless whole, capable of functioning as a single, integrated system.

Having thus described the invention in rather full detail, it will be understood that such detail need not be strictly adhered to, but that further changes and modifications may suggest themselves to one skilled in the art falling within the scope of the present invention as defined by the subjoined claims.

What is claimed is:

1. A communications network in which telephone calls dialed on the Public Switched Telephone Network (PSTN) create an Internet communication between the calling and called devices, and in which the PSTN maintains control of such Internet communications, comprising:
(a) the PSTN and its component systems, including Central Office switching systems and the SS7 network;
(b) a plurality of user devices, including phones which incorporate a display screen;
(c) a plurality of communications systems for answering and processing user calls, optionally including Voice Mail Systems, Automated Attendant systems, and PBXs;
(d) PSTN component systems, including Central Office switching systems, providing telecommunications services for subscriber user devices and communications system;
(e) a call control messaging system interconnecting said PSTN component systems with said user devices and said communications systems; and
(f) call control messages of said messaging system for effecting call control functions over Internet communications, including initiating calls, call transferring, and call termination;
wherein said subscriber user devices and communications systems send said call control messages to said serving PSTN component systems to initiate call control functions for an Internet communication, and wherein said serving PSTN component systems operate in response to said call control messages to effect the associated call control function by initiating, transferring, or terminating the Internet communication.

2. A communications network as recited in claim 1, further comprising:
(a) said user devices incorporating a display screen;
(b) an Interactive Device Control messaging system operable with said user devices and said communications systems, said communications system sending Interactive Device Control messages to said user devices for presentation on said display screen;
(c) said displayed messages including one or more user selectable response elements, said selectable response elements each being associated with a unique response message;
(d) said Interactive Device Control messaging system providing for said user device to send said response message to said communications system;
(e) said response messages influencing or controlling the operation or function of said communications system to cause said communications system to initiate call control functions such as to transfer a call from said user device; and
(f) said communications system being respondent to the receipt of said response message by sending an associated call control message to said serving PSTN component system, thereby causing said PSTN component system to effect the desired call control function.

3. A communications network as recited by claim 1, wherein said user device is an Integrated Device, having an Internet connection with an associated IP address and a PSTN connection with an associated telephone number.

4. A communications network as recited by claim 1, wherein said communications system is a user device such as a display phone.

5. A communications network as recited by claim 2, wherein said Interactive Device Control messaging system conveys interactive device control messages between corresponding communications systems and user devices via the Internet or the PSTN.

6. A communications network as recited by claim 1, wherein said call control messaging system utilizes the PSTN SS7 messaging network for communicating with PSTN devices.

7. A communications network as recited by claim 1, wherein said call control messaging system utilizes the PSTN ISDN messaging capability, and wherein the messages of said call control messaging system are compatible with message standards for the ISDN protocol.

8. A plurality of PSTN component systems operable with a call control messaging system for voice and multimedia communications, comprising:
(a) a plurality of PSTN component systems, optionally including telco Central Office switching systems, operable to receive call control messages from a subscriber system;
(b) said call control messages relating to the establishment, termination, transfer, or other call control function to be performed for a communication that in part or in whole traverses the Internet; and
(c) said PSTN component systems being configured to execute said call control function upon receipt of said call control messages from said subscriber system.

9. The PSTN component systems as recited by claim 8, wherein said PSTN component systems are local and long distance telephone central office systems.

10. The PSTN component systems as recited by claim 8, wherein said PSTN component systems are telephone central office system interface devices, optionally including those providing DSL access, cable-TV access, and fixed and cellular wireless access, and which provide telephony and Internet services for client devices.

11. Communications systems and devices operable with an Interactive Device Control messaging system for voice and multimedia communications, comprising:
(a) communications systems and devices operable to send Interactive Device Control messages to user display phones, said messages presenting user selectable options on the user display phone screen;
(b) said communications systems and devices operable to receive response messages generated by said user selectable options when acted upon by the user;
(c) said response messages controlling or influencing a communications function such as the processing of a phone call by one of said communications systems or devices; and
(d) said communications systems and devices operable to send a call control message to a serving PSTN component system, said call control message being selected to cause said PSTN component to execute the communications function indicated by said response message.

12. Communications systems and devices as recited by claim 11, wherein said presented message provides a selectable option which activates a communications function at the calling device, including initiating a call to a specified telephone number.

13. Communications systems and devices as recited by claim 11, wherein said communications systems and devices are PSTN component systems, including local and long distance central office switching systems, and wherein said PSTN component system reacts to said response message as if it received a call control message from a subscriber device, or wherein said response message is a call control message to which said PSTN component system reacts in the same fashion as if said call control message were received from a subscriber device.

14. Communications systems and devices as recited by claim 11, wherein said communications systems and devices are office telephone systems including PBX systems, Key Systems, and Automatic Call Distributor systems.

15. Communications systems and devices as recited by claim 11, wherein said communications systems and devices are adjunct devices including automated attendant systems and voice mail systems.

16. Communications systems and devices as recited by claim 11, wherein said communications systems and devices are Internet communications devices including Personal Computers or servers.

17. Communications systems and devices as recited by claim 11, wherein said communications systems and devices are wireless communications devices including cellular phones having a display screen.

18. Communications systems and devices as recited by claim 11, wherein said communications systems and devices are user devices such as phones having a display screen.

19. Communications systems and devices as recited by claim 11, wherein said communications systems and devices are Integrated Devices having an Internet connection with an associated IP address and a PSTN connection with an associated telephone number, and having a display screen.

20. A user display phone operable with an Interactive Device Control messaging system in which said display phone initiates a request for control of a communications system by user activation of an information call mode, comprising:
(a) an information call mode of said display phone presenting a selectable control on the display screen, said control being associated with an information call message;
(b) a means for the user to dial the telephone number of a communications system while in the information call mode; and
(c) said information call mode initiating an information call message on the PSTN to the called communications system or device, said information call message requesting interactive control of the called system or device without establishing a voice call to that device or causing the device to ring, whereby said called communications system responds to said information call message by sending an informational message for presentation on said user display phone.

21. An Interactive Device Control messaging system for voice and multimedia communications in which a communications system offers control over one or more of its functions to a user device such as a display phone in response to a call setup request on the PSTN from said user device, said offer for control being accomplished by said communications system sending a message for presentation of the user phone display screen, said message incorporating selectable response elements which, when activated by the user, initiate the control function.

22. An Interactive Device Control messaging system as recited by claim 21, wherein said communications system is a local or long distance telephone Central Office system responsible for processing said call setup request.

23. An Interactive Device Control messaging system as recited by claim 21, wherein said communications system offers control of its communications functions by sending a message for presentation to a calling user display phone while rejecting the call setup request received from the calling user on the PSTN.

24. A PSTN Interactive Device Control messaging system for subscriber user display phones to control telephone Central Office services and features, comprising:
(a) user display phones;
(b) an Interactive Device Control messaging system utilizing Out Of Band Signaling;
(c) telephone Central Office systems operable to send Interactive Device Control messages to subscriber user display phones, said messages presenting communications related information on the user display phone screen, said information optionally comprising user selectable options;
(d) said user display phones operable to initiate sending Interactive Device Control messages to said telephone Central Office systems;
(e) said telephone Central Office systems operable to receive Interactive Device Control messages generated by said user selectable options when acted upon by the user, and to receive Interactive Device Control messages initiated by said user display phone; and
(f) wherein said telephone Central Office systems in response to receiving said Interactive Device Control messages provide said user display phone information and selectable control options relating to administrative communications functions including subscriber services operational communications functions that control or influence the processing of a phone call.

25. A PSTN Interactive Device Control messaging system as recited in claim 24, wherein said information and control options provide for informational status and administration of subscription services such as Call Forwarding.

26. A PSTN Interactive Device Control messaging system as recited in claim 24, wherein said information and control options are related to a call, to activate a function optionally including Call Trace or Repeat Call.

27. A PSTN Interactive Device Control messaging system as recited in claim 24, wherein said information and control options relate to communications functions having billable fees chargeable to the subscriber.

28. A PSTN Interactive Device Control messaging system as recited in claim 24, wherein said telephone Central Office systems comprise a billing system.

29. A PSTN Interactive Device Control messaging system as recited in claim 24, wherein said telephone Central Office systems comprise a service ordering system.

30. An Interactive Device Control messaging system for voice and multimedia communications in which a Voice Mail System offers control over one or more of its caller functions to a calling user display phone, said offer for control being accomplished by said communications system sending a message for presentation of the user phone display screen, said message incorporating selectable response elements which, when activated by the user, initiate the control function.

31. An Interactive Device Control messaging system as recited in claim 30 in which the control function enables the caller to review, change, or delete their message.

32. An Interactive Device Control messaging system as recited in claim 30 in which the control function enables the caller to assign a priority to their message.

33. An Interactive Device Control messaging system as recited in claim 30 in which the control function enables the caller to transfer their call.

34. An Interactive Device Control messaging system as recited in claim 30 in which the control function enables the caller to designate the media type of a message to be recorded, such as to leave a voice only message, to leave a videophone message, or to leave an Electronic Business Card.

35. A method of operation of a communications system or device for voice and multimedia communications which provides Interactive Device Control capabilities to a calling device, comprising the steps of:
(a) receiving a call setup request message for Internet communications from a user device such as a display phone, wherein said communications system may be another user display phone, and wherein said call setup request message is delivered via the PSTN;
(b) establishing an Internet communication with said calling user device;
(c) sending a message for presentation on the calling device's display screen, said message to include calling user selectable options for controlling the user's call;
(d) receiving a message comprising the calling user's selection of the presented options, wherein said selection affects the user's call, such as by transferring the call; and
(e) effecting the calling user selected option by sending a call control message to the serving PSTN entity for said communications system, causing said PSTN entity to execute the desired action on the user's call.

36. A method of operation of a communications system or device for voice and multimedia communications which provides Interactive Device Control capabilities to a calling device, comprising the steps of:
(a) receiving a call setup request message for Internet communications from a user device such as a display phone, wherein said communications system may be another user display phone, and wherein said call setup request message is delivered via the PSTN;
(b) rejecting the Internet communication request from the calling user device by sending a call control message to the serving PSTN entity for said communications system, causing said PSTN entity to execute the desired action on the user's call; and
(c) sending a message for presentation on the calling device's display screen.

37. A method of operation of a communications system or device for voice and multimedia communications which provides Interactive Device Control capabilities to a calling device, comprising the steps of:
(a) receiving an information call request message for Internet communications from a user device such as a display phone, wherein said communications system may be another user display phone, and wherein said information call request message is delivered via the PSTN; and
(b) sending a message for presentation on the calling device's display screen, said message to include calling user selectable options for controlling the user's call.

38. A method of operation of a communications system or device as recited in claim 52, wherein said message for presentation on the calling device's display screen includes a calling user selectable option to initiate a call to a pre-designated telephone number.
